(19) United States
(12) Patent Application Publication
(10) Pub. No.: US 2026/0322930 A1
(43) Pub. Date: Oct. 15, 2026

(54) PRINTING APPARATUS, METHOD FOR CONTROLLING PRINTING APPARATUS, AND SYSTEM

(71) Applicant: CANON KABUSHIKI KAISHA, Tokyo (JP)

(72) Inventor: KAZUHISA FUJINO, Kanagawa (JP)

(21) Appl. No.: 19/637,443

(22) Filed: Apr. 2, 2026

(30) Foreign Application Priority Data
Apr. 10, 2025 (JP) 2025-065060

(51) Int. Cl. H04N 1/00

(52) U.S. Cl. CPC H04N 1/00652; H04N 1/00602; H04N 1/0066; H04N 1/00663; H04N 2201/0082

(57) ABSTRACT

There is provided a printing apparatus including: a first conveyance unit for conveying a printing medium; a second conveyance unit located upstream from the first conveyance unit; and at least one memory and at least one processor which function as: a first control unit for controlling the first conveyance unit; and a second control unit for controlling the second conveyance unit and connected to the first control unit via a communication line, wherein the first control unit transmits, to the second control unit, driving information on a driving amount of the second conveyance unit for driving scheduling of the second conveyance unit, and receives a completion notification of the scheduling from the second control unit, and thereafter transmits, to the second control unit, an interrupt signal for driving the second conveyance unit in synchronization with the first conveyance unit based on the driving information, and drives the first conveyance unit.

### BACKGROUND

### Field of the Technology

The present disclosure relates to a printing apparatus, a method for controlling a printing apparatus, and a system.

### Description of the Related Art

In recent years, an increasing number of printing apparatuses accommodate multiple sheet feeding cassettes as options in order to meet the demand for printing on multiple types of printing media. In such a printing apparatus, a feeder unit that houses sheet feeding cassettes may be controlled by a second CPU different from a first CPU that controls the main unit of the printing apparatus. Specifically, during the conveyance of printing media, the first CPU and the second CPU are required to synchronize motor driving in the printing apparatus main unit and motor driving in the sheet feeding cassettes.

Literature (Japanese Patent Laid-Open No. 2011-215372) discloses a method for synchronizing motors controlled by a first CPU with motors controlled by a second CPU using a technique that combines a serial communication line with a communication line for synchronization between the CPUs.

Unfortunately, according to the configuration in the above literature, achieving high-precision conveyance control with appropriate synchronization among multiple motors may be difficult for a printing apparatus like a serial printing apparatus, which intermittently repeats conveyance of a printing medium. An object of the present disclosure is to achieve higher-precision conveyance control of a printing medium in a configuration using simple communication means.

### SUMMARY

A printing apparatus according to an aspect of the present disclosure comprises: a first conveyance unit configured to convey a printing medium along a conveyance path for conveying the printing medium; a second conveyance unit located upstream from the first conveyance unit in a direction in which the printing medium is conveyed through the conveyance path; and at least one memory and at least one processor which function as: a first control unit configured to control the first conveyance unit; and a second control unit configured to control the second conveyance unit and connected to the first control unit via a communication line, wherein the first control unit transmits, to the second control unit, driving information on a driving amount of the second conveyance unit for scheduling of driving of the second conveyance unit, and receives a notification of completion of the scheduling from the second control unit, and thereafter transmits, to the second control unit, an interrupt signal for driving the second conveyance unit in synchronization with the first conveyance unit based on the driving information, and drives the first conveyance unit.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an example of the configuration of a printing apparatus;

FIG. 2 is a block diagram illustrating an example of the hardware configuration of the printing apparatus and a feeder unit;

FIG. 3 is a cross-sectional view of the printing apparatus and the feeder unit, illustrating an example of a conveyance path for printing media;

FIG. 4 is a diagram illustrating an example of the software configuration of the printing apparatus and the feeder unit;

FIG. 5 is a command table illustrating an example of a command format that is predetermined between the printing apparatus and the feeder unit;

FIG. 6 is a flowchart illustrating an example of print control performed by the printing apparatus, and printing-medium conveyance control performed by the printing apparatus and the feeder unit in association with the print control;

FIG. 7 is a diagram showing the relationship of FIGS. 7A and FIG. 7B, and FIG. 7A and FIG. 7B are a sequence diagram illustrating an example of sheet feed control performed by the printing apparatus for feeding a printing medium from a sheet feeding cassette;

FIG. 8 is a diagram illustrating an example of a conveyance control sequence for controlling conveyance so that the printing medium reaches under a print head;

FIG. 9 is a sequence diagram illustrating an example of control performed in a case where a sheet feeding cassette is attached to the printing apparatus;

FIG. 10 is a sequence diagram illustrating an example of motor stop control performed in a case where a sheet feeding cassette is pulled out during sheet feed control or conveyance control that uses sheet feed motors;

FIG. 11 is a diagram showing the relationship of FIGS. 11A and FIG. 11B, and FIG. 11A and FIG. 11B are a diagram illustrating an example of motor stop scheduling performed by the printing apparatus and the feeder unit; and

FIG. 12 is a diagram illustrating an example of motor stop control performed by the printing apparatus and the feeder unit.

### DESCRIPTION OF THE EMBODIMENTS

Preferred embodiments of the present disclosure will be described in detail below with reference to the attached drawings. Note that the following embodiments are not intended to limit the scope of the present disclosure, and not all combinations of features described in the following embodiments are necessarily essential to the solutions of the present disclosure. Like components will be described with like reference numerals.

Conventional image forming apparatuses (printing apparatuses) typically use a single CPU to control motors for conveying printing media. In recent years, the demand for printing on multiple types of printing media has been increasing. To meet this demand with a single printer, an increasing number of printing apparatuses allow users to purchase and install multiple sheet feeding cassettes as options.

In such a printing apparatus, a feeder unit that houses sheet feeding cassettes may be controlled by a second CPU different from a first CPU that controls the main unit of the printing apparatus. That is, in a printing apparatus in this configuration, the first CPU and the second CPU exchange control information and instructions to perform control such as printing-medium conveyance control.

Now, a known technique for cost-effectively establishing communication between the CPUs combines a serial communication line with a communication line for synchronization between the CPUs. In a laser printer or a line-head printer, a printing medium simply needs to be conveyed at a constant speed during print operation. Therefore, printing-medium conveyance motors controlled by the CPU of the printing apparatus main unit and printing-medium conveyance motors controlled by the CPU of the feeder unit simply need to be synchronized once at the start of the print operation, and then conveyance operation may be started. However, in a serial printer, which alternately repeats a print scan by a print head for one band and a conveyance operation over a distance corresponding to one band, conveyance motors in the main unit and conveyance motors in the feeder unit need to be synchronized at the start and end of the conveyance operation for each band. The distance between the synchronized driving and stopping is therefore short in a serial printer. Applying the conventional configuration to a serial printer requires a large number of control commands for conveyance motor synchronization to be exchanged between the CPUs via a serial communication line before the completion of printing on one printing medium. As more commands are exchanged, even slight conveyance errors accumulate and become significant. In addition, such errors increase in proportion to the number of conveyance motors controlled by the CPU for the sheet feeding cassettes. Consequently, misalignment in the synchronized driving and stopping also increases between the motors in the printing apparatus main unit and the motors in the feeder unit.

The present disclosure involves including, in control information transmitted and received between the CPU of the main unit of a printing apparatus and the CPU of a feeder unit, information necessary for the synchronized driving and stopping of a printing medium. That is, details of synchronization control, such as the motor speed and the driving amount, are determined in advance using the control information. This can eliminate the need for an additional synchronization communication line and also reduce the number of commands exchanged via a serial communication line. Thus, misalignment in the synchronized driving and stopping of conveyance motors can be prevented.

The following embodiments will describe a method by which higher-precision conveyance control with a simple communication configuration can be achieved in a serial printer having separate CPUs for the main unit of a printing apparatus and for a feeder unit.

### First embodiment

### Configuration of a printing apparatus and a feeder unit

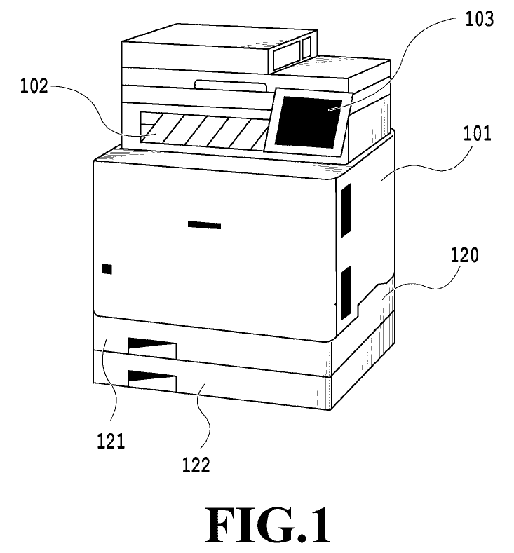

FIG. 1 is a perspective view illustrating an example of the configuration of a printing apparatus 101 in the present disclosure. The printing apparatus 101 in the present embodiment forms an image on a printing medium being conveyed (which may be expressed as printing or recording) while moving a carriage with a print head along a direction intersecting a conveyance direction of the printing medium. That is, the printing apparatus 101 in the present embodiment is described, by way of example, as a serial printer that forms an image on a printing medium intermittently, one line at a time.

The printing apparatus 101 includes an output tray 102 and an operation panel 103. The output tray 102 is a tray where printing media (print products) with images formed thereon are stacked. The operation panel 103 is a display unit that controls display of the status and configuration information of the printing apparatus 101, and notifications or messages for a user. The operation panel 103 can also display predetermined screens or receive instructions to the printing apparatus 101.

A feeder unit 120 is attached below the printing apparatus 101. The feeder unit 120 is a device for holding printing media to be fed to the printing apparatus 101. The feeder unit 120 in the present embodiment has a circuit board (hereinafter referred to as a sheet feeding circuit board) different from a circuit board (hereinafter referred to as a main unit circuit board) in the printing apparatus 101. In a case where a printing media is fed from the feeder unit 120 to the printing apparatus 101, the sheet feeding circuit board controls the feeding according to commands received from the main unit circuit board.

The feeder unit 120 in the present embodiment is described, by way of example, as having two-tiered cassettes: sheet feeding cassettes 121 and 122. Note that the feeder unit 120 may have only one or more than two sheet feeding cassettes. A user of the printing apparatus 101 can pull out the sheet feeding cassettes to set printing media therein. The feeder unit 120 is detachably attachable to the printing apparatus 101. In the present embodiment, the feeder unit 120 and the printing apparatus 101, configured as separate units, function as a single image forming apparatus.

### Hardware configuration of the printing apparatus and the feeder unit

### Hardware configuration of the printing apparatus

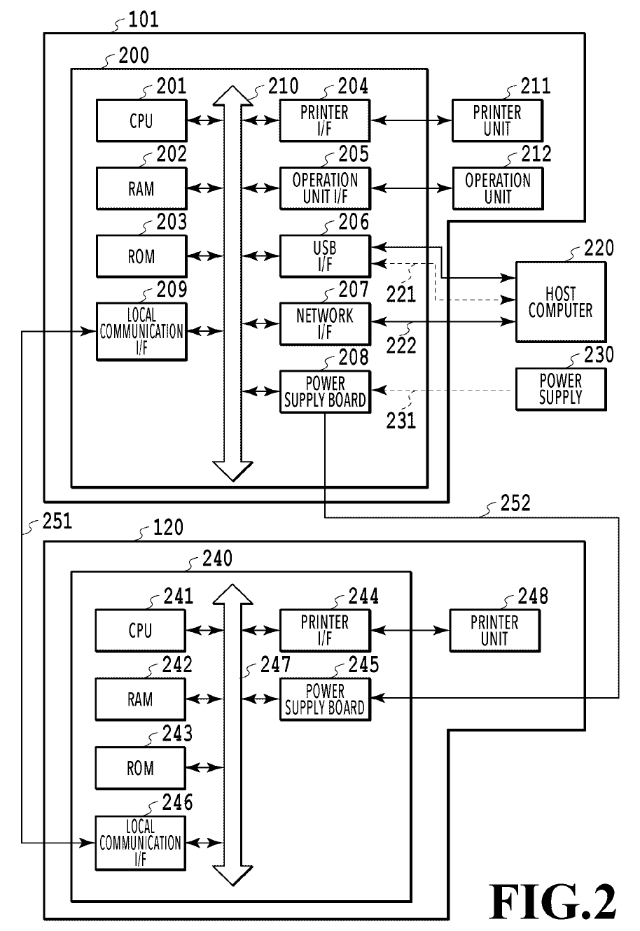

FIG. 2 is a block diagram illustrating an example of the hardware configuration of the printing apparatus 101 and the feeder unit 120 in the present disclosure. The printing apparatus 101 includes a control unit 200, a printer unit 211, and an operation unit 212. The control unit 200 includes a CPU 201, a RAM 202, a ROM 203, a printer interface (I/F) 204, an operation unit I/F 205, a USB I/F 206, a network I/F 207, a power supply board 208, and a local communication I/F 209. These components are interconnected via a system bus 210.

The printing apparatus 101 performs various sorts of control, such as power-on control, print control, and printing-medium conveyance control, by causing the CPU 201 in the control unit 200 to load control programs stored in the ROM 203 into the RAM 202 and execute the loaded programs.

The RAM 202 is the main memory for the CPU 201 and is used as a work area or as a temporary storage area for loading various programs stored in the ROM 203. The ROM 203 stores image data, various programs, and various configuration information items. Although the ROM 203 in the present disclosure is described as flash storage as an example, the ROM 203 may be an auxiliary storage device such as a hard disk.

As an example, the printing apparatus 101 in the present disclosure is described such that the single CPU 201 uses a single memory (the RAM 202) to perform each processing operation shown in the flowcharts described below. Note that the manner of performing each of the processing operations is not limited to this. For example, each of the processing operations shown in the flowcharts described below may be performed by cooperation of multiple CPUs and multiple RAMs, ROMs, and storage devices. Each of the processing operations may be performed in part using hardware circuits.

The printer I/F 204 interfaces between the printer unit 211 and the control unit 200. Print data to be printed by the printer unit 211 is transferred from the control unit 200 via the printer I/F 204 to the printer unit 211, which then prints an image corresponding to the print data onto a printing medium such as a paper sheet. The print data is CMYK data obtained by converting RGB image data sent from a host computer 220.

The operation unit I/F 205 interfaces between the operation unit 212 and the control unit 200. The operation unit 212 corresponds to the operation panel 103. The operation unit 212 includes a liquid crystal display unit with a touch panel function, and is provided with operation keys for receiving instructions to the printing apparatus 101. That is, the operation unit 212 functions as a reception unit that receives user instructions.

The local communication I/F 209 is connected to a local communication I/F 246 of the feeder unit 120 via a local communication line 251. The local communication line 251 includes a serial communication line capable of data exchange through serial communication, and an interrupt line capable of transmitting interrupt signals. The communication scheme for serial communication in the present disclosure is described, by way of example, as asynchronous communication scheme that uses a serial communication protocol. For example, serial communication in the present disclosure can adopt universal asynchronous receiver/transmitter (UART).

The USB I/F 206 and the network I/F 207 control, via a USB cable 221 and a network 222, respectively, communication with the host computer 220 connected to the printing apparatus 101. The power supply board 208 transforms power supplied from a power supply 230 via a power supply cable 231 and supplies the power to the printing apparatus 101. The power supply board 208 may include a storage battery capable of storing power.

### Hardware configuration of the feeder unit

The feeder unit 120 includes a control unit 240 and a printer unit 248. The control unit 240 includes a CPU 241, a RAM 242, a ROM 243, a printer I/F 244, a power supply board 245, and a local communication I/F 246.

The feeder unit 120 performs various sorts of control, such as power-on control and printing-medium conveyance control associated with print control, by causing the CPU 241 in the control unit 240 to load control programs stored in the ROM 243 into the RAM 242 and execute the loaded programs.

The RAM 242 is the main memory for the CPU 241 and is used as a work area or as a temporary storage area for loading various programs stored in the ROM 243. The ROM 243 stores various programs and various configuration information items. Although the ROM 243 in the present disclosure is described as flash storage as an example, the ROM 243 may be an auxiliary storage device such as a hard disk.

Note that as an example, the feeder unit 120 is described such that the single CPU 241 uses a single memory (the RAM 242) to perform each of the processing operations shown in the flowcharts described below. The manner of performing each of the processing operations is not limited to this. For example, each of the processing operations shown in the flowcharts described below may be performed by cooperation of multiple CPUs and multiple RAMs, ROMs, and storage devices. Each of the processing operations may be performed in part using hardware circuits.

The printer I/F 244 interfaces between the printer unit 248 and the control unit 240. The printer unit 248 of the feeder unit 120 performs operations such as printing-medium conveyance control associated with print control performed by the printer unit 211 of the printing apparatus 101, and the detection of attaching and detaching of the feeder unit 120 to and from the printing apparatus 101. Signals for control performed by the printer unit 248 are transferred from the control unit 240 to the printer unit 248 via the printer I/F 244.

The power supply board 245 transforms power supplied from the power supply board 208 of the printing apparatus 101 via a power supply wire 252 and supplies the power to the feeder unit 120. The power supply board 245 may include a storage battery capable of storing power, or receive power from a source different from the power supply 230 for the printing apparatus 101.

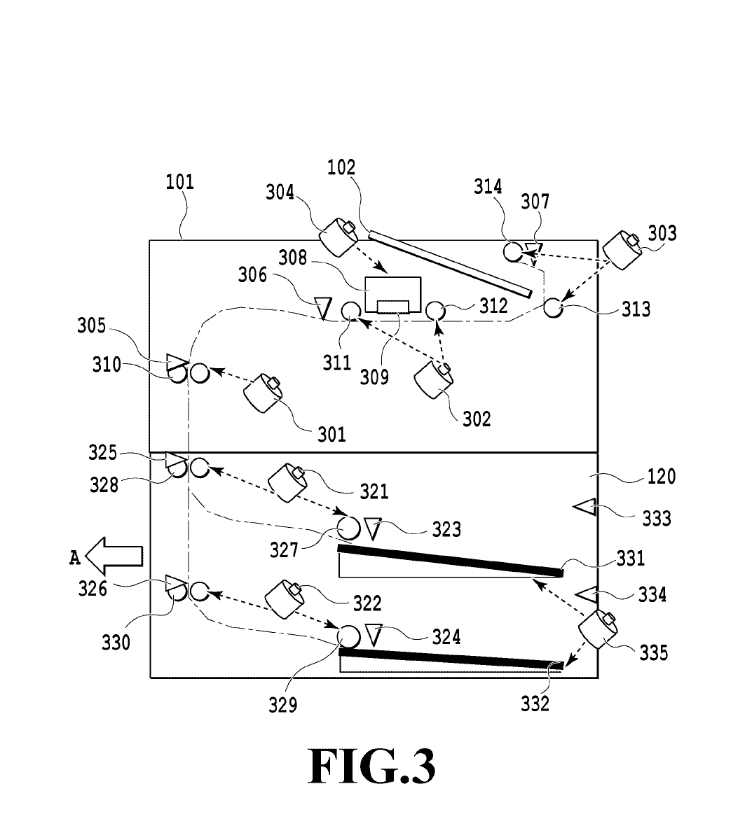

FIG. 3 is a cross-sectional view of the printing apparatus 101 and the feeder unit 120 in the present disclosure, illustrating an example of a conveyance path for printing media. The printing apparatus 101 includes: a conveyance motor 301 that drives a conveyance roller pair 310; a print motor 302 that drives print rollers 311 and 312; and a sheet discharge motor 303 that drives sheet discharge rollers 313 and 314. The printing apparatus 101 includes a carriage motor 304 that drives a carriage 308 having a print head 309. These motors in the printing apparatus 101 are controlled by the control unit 200. The printing apparatus 101 also includes sheet detection sensors 305 to 307 that detect a printing medium passing through the conveyance path. That is, the sheet detection sensors detect the passing of the printing medium. The sheet detection sensors enable the detection of the position of the printing medium.

The feeder unit 120 includes: a sheet feed motor 321 that drives a sheet feed roller 327 and a conveyance roller pair 328; a sheet feed motor 322 that drives a sheet feed roller 329 and a conveyance roller pair 330; and a pressure plate motor 335 that operates pressure plates 331 and 332. These motors in the feeder unit 120 are controlled by the control unit 240 according to instructions from the control unit 200. The rollers and motors in the feeder unit 120 are located upstream from the rollers and motors in the printing apparatus 101 along the conveyance path for printing media.

The feeder unit 120 also includes sheet detection sensors 325 and 326. In a case where the sheet feeding cassette 121 or 122 is attached, the feeder unit 120 causes the pressure plate motor 335 to raise the corresponding pressure plate. In a case where a printing medium is set in the sheet feeding cassette in this case, the printing medium is raised by the pressure plate. The feeder unit 120 thus causes the raised printing medium to contact the corresponding sheet feed roller. At this point, the feeder unit 120 detects, via a sheet presence sensor 323 or 324, the presence or absence of the printing medium in the sheet feeding cassette. That is, the sheet presence sensors 323 and 324 each detect whether the corresponding sheet feeding cassette contains a printing medium.

The feeder unit 120 includes cassette attaching/detaching detection sensors 333 and 334. The feeder unit 120 can detect, via the cassette attaching/detaching detection sensor 333, the attaching and detaching of the sheet feeding cassette 121 to and from the printing apparatus 101. Similarly, the feeder unit 120 can detect, via the cassette attaching/detaching detection sensor 334, the attaching and detaching of the sheet feeding cassette 122. Although the cassette attaching/detaching detection sensors in the present disclosure are described, by way of example, as being provided in the feeder unit 120 for the respective sheet feeding cassettes, the location where the cassette attaching/detaching detection sensors are provided is not limited to the feeder unit 120. For example, a cassette attaching/detaching detection sensor may be provided in the printing apparatus 101 to detect the attaching and detaching of the sheet feeding cassettes to and from the printing apparatus 101.

The sheet feeding cassettes in the present disclosure are pulled out (detached from the printing apparatus 101) in the direction A shown in FIG. 3. Consider an example in which the sheet feeding cassette 121 is pulled out. This causes the conveyance path for printing media in the sheet feeding cassettes 121 and 122 (a second conveyance path) to be disconnected from the conveyance path for printing media in the printing apparatus 101 (a first conveyance path), thus preventing sheet feeding. The second conveyance path is located upstream from the first conveyance path along the conveyance path for printing media.

The configuration of the conveyance path in the present disclosure is merely exemplary and may be a configuration in which the conveyance path for printing media is not interrupted by the pulling out of the sheet feeding cassette 121. Alternatively, the configuration of the conveyance path in the present disclosure may be a configuration in which a mechanism opened in response to an operation from outside is provided in the printing apparatus 101 or the feeder unit 120 as part of the conveyance path for printing media and the conveyance path for printing media is interrupted by the opening of the mechanism.

### Software configuration of the printing apparatus and the feeder unit

### Software configuration of the printing apparatus

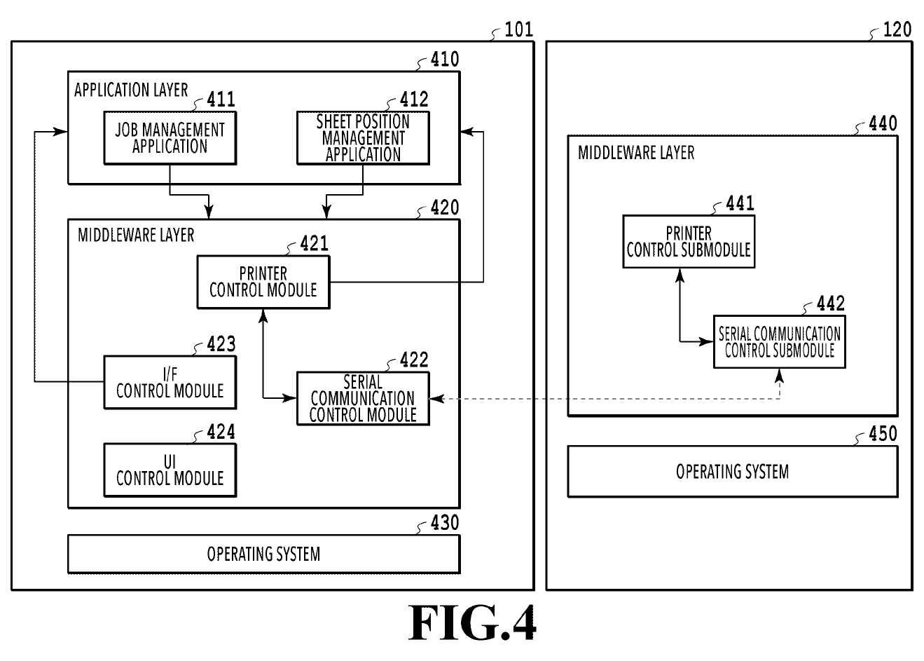

FIG. 4 is a diagram illustrating an example of the software configuration of the printing apparatus 101 and the feeder unit 120 in the present disclosure. Control programs for controlling hardware modules of the printing apparatus 101 in the present disclosure are loaded into the RAM 202. The control programs for the printing apparatus 101 are broadly divided into three layers: an application layer 410 for managing applications; a middleware layer 420 for controlling devices via various I/Fs; and an operating system 430 for managing the overall control of the printing apparatus 101. The role of each layer will be described.

The operating system 430 provides basic functions for the control unit 200 to execute the control programs. The middleware layer 420 includes a group of software items for controlling the printer I/F 204 and I/Fs corresponding to physical devices. The middleware layer 420 in the present disclosure includes a printer control module 421 as a module for controlling the printer I/F 204. The middleware layer 420 includes a serial communication control module 422 as a module for controlling communication between the printing apparatus 101 and the feeder unit 120. The middleware layer 420 includes an I/F control module 423 for controlling the USB I/F 206 and the network I/F 207, which are devices used for communication with the host computer 220. The middleware layer 420 includes a UI control module 424 for controlling the operation unit I/F 205.

The application layer 410 includes a group of applications for providing users with functions of the printing apparatus 101, such as a print function, by operating each device via corresponding middleware in the middleware layer 420. For example, in a case where the UI control module 424 detects a print execution instruction via the operation unit I/F 205 upon a user operation on the operation unit 212, the application layer 410 is notified of the print execution instruction. In response to this instruction, a job management application 411, which provides the print function, uses the printer control module 421 in the middleware layer 420 to cause the printer unit 211 to perform print operation.

### Software configuration of the feeder unit

Control programs for controlling the printer unit 248 of the feeder unit 120 are loaded into the RAM 242. The control programs for the feeder unit 120 are broadly divided into two layers: a middleware layer 440 for controlling devices via various I/Fs; and an operating system 450 for managing the overall control of the feeder unit 120. The role of each layer will be described.

The operating system 450 provides basic functions for the control unit 240 to execute the control programs. The middleware layer 440 includes a group of software items for controlling the printer I/F 244 and I/Fs corresponding to physical devices. The middleware layer 440 in the present disclosure includes a printer control submodule 441 as a module for controlling the printer I/F 244. The middleware layer 440 also includes a serial communication control submodule 442 as a module for controlling communication between the printing apparatus 101 and the feeder unit 120.

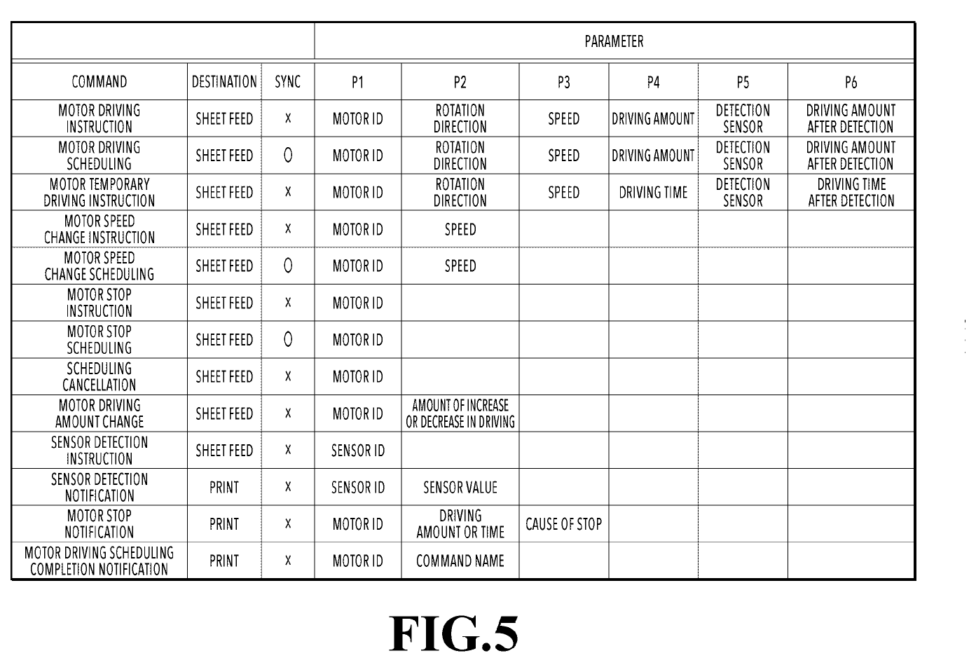

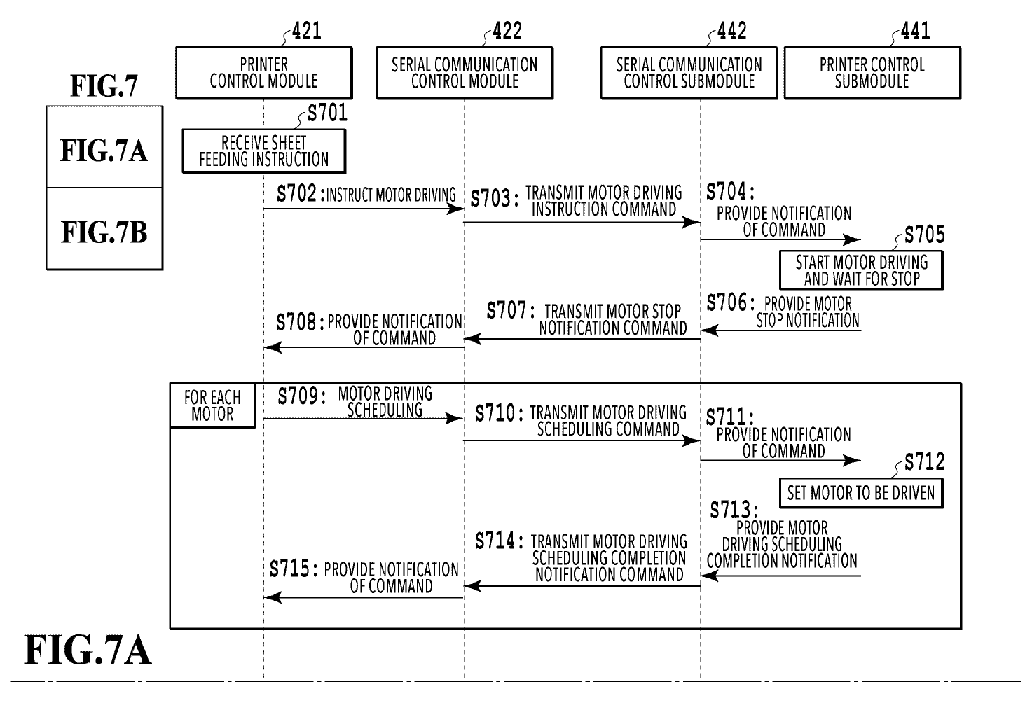

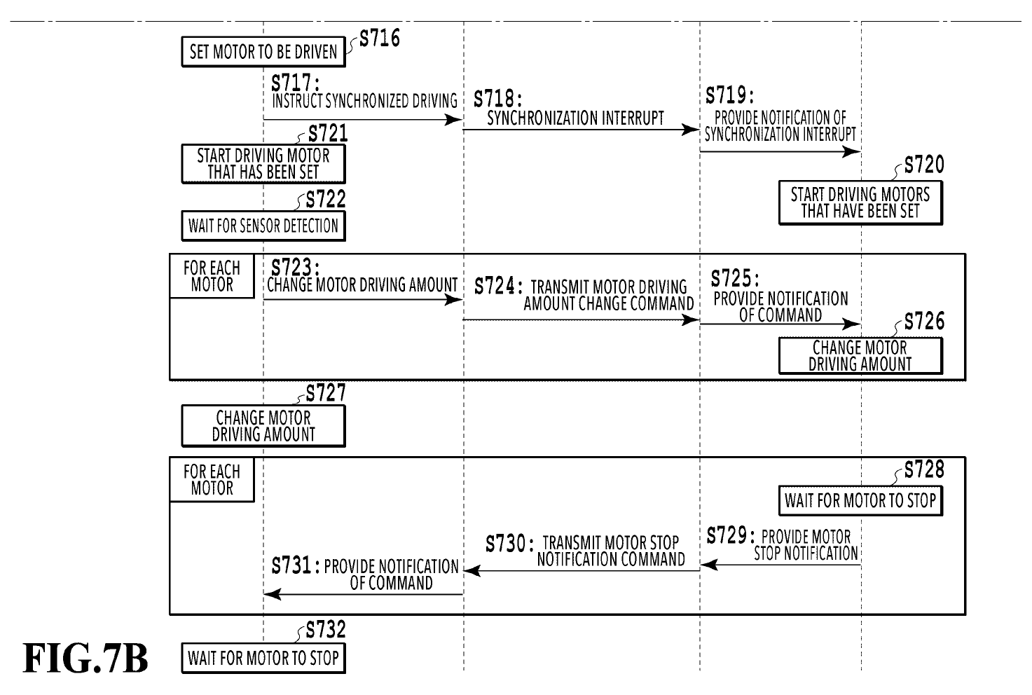

FIG. 5 is a command table illustrating an example of a command format that is predetermined between the printing apparatus 101 and the feeder unit 120. These commands are used for various sorts of control described below with reference to FIGS. 7-12. The commands in the command table shown in FIG. 5 are exchanged through serial communication via the local communication line 251 (see FIG. 2). Each command in the command table shown in FIG. 5 is assigned a command name, a command destination, and synchronization information. The synchronization information indicates whether the command is to be executed in response to the reception of an interrupt signal via the local communication line 251. A command marked with "O" in the synchronization information is not executed immediately after being received by the destination of the command. Rather, the command is executed in response to the reception of an interrupt signal that indicates synchronization timing. A command marked with "X" in the synchronization information is executed immediately after being received by the destination of the command.

Each command in the command table shown in FIG. 5 is further assigned predetermined parameters P1 to P6. Parameter P1 specifies the motor ID that uniquely identifies the motor to be driven or stopped according to the corresponding command. Parameters P2 to P6 each specify a detail of the command. For example, with reference to the parameters of a command named "motor driving scheduling," P2 specifies the motor rotation direction, P3 specifies the motor speed, and P4 specifies the motor driving amount. P5 specifies the type of the detection sensor used to detect the position of the printing medium, and P6 specifies the motor driving amount after detection by that detection sensor. The driving amount refers to the rotation amount of the motor. For example, in a case where the motor is a conveyance motor, the driving amount corresponds to the conveyance distance of the printing medium. Thus, predefining the meaning of the parameters eliminates the need for tags indicating the purposes of the parameters, leading to a reduced communication volume. Note that each command transmitted and received between the printing apparatus 101 and the feeder unit 120 does not need to have values set for all these parameters. For example, in a case where the "motor driving scheduling" command is transmitted, parameters P5 and P6 do not necessarily need to be set.

Here, a case where the feeder unit 120 receives a command named "motor driving instruction" from the printing apparatus 101 will be described. In this case, the printer control submodule 441 immediately drives a motor (the motor indicated by P1) in the printer unit 248 via the printer I/F 244 according to the parameters of "motor driving instruction" in the command table. This type of command is effective in a case where only one motor is to be driven, i.e., no other motors are to be synchronized with that motor.

Furthermore, a case where the feeder unit 120 receives a command named "motor driving scheduling" from the printing apparatus 101 will be described. In this case, the printer control submodule 441 does not immediately drive the motor upon receiving the command. Subsequently, upon receiving an interrupt signal, the printer control submodule 441 drives the motor in the printer unit 248 via the printer I/F 244 according to the parameters of "motor driving scheduling." That is, this command enables prescheduling motors to be driven so that the driving of the scheduled motors is simultaneously triggered via the interrupt signal line. This type of command is effective in a case where multiple motors in the feeder unit 120 are to be driven simultaneously, or in a case where motors in the printing apparatus 101 and motors in the feeder unit 120 are to be driven simultaneously (synchronized). This type of command also enables stopping motors simultaneously by aligning the motor driving amount corresponding to the conveyance distance of the print sheet and by simultaneously starting the driving of the motors.

Note that the commands and their parameters shown in FIG. 5 are merely exemplary; other commands and parameters may be predetermined between the printing apparatus 101 and the feeder unit 120. For example, the command parameters may include the conveyance distance of the printing medium, the motor rotation speed (or the conveyance speed of the printing medium) after the printing medium is detected by a sheet detection sensor, and the conveyance distance of the printing medium after the printing medium is detected by the sheet detection sensor. The command parameters may also include the number of delayed pulsed signals (delayed pulses) to be transmitted to the motor. The motor driving amount indicated by a command parameter is, for example, a driving amount adjusted depending on the motor speed so that the motors to be synchronized stop simultaneously. Thus, the printing apparatus 101 can use a command to provide a notification in advance to the feeder unit 120, indicating information that is not necessary for motor control immediately after the transmission and reception of the command but that is necessary for subsequent motor control.

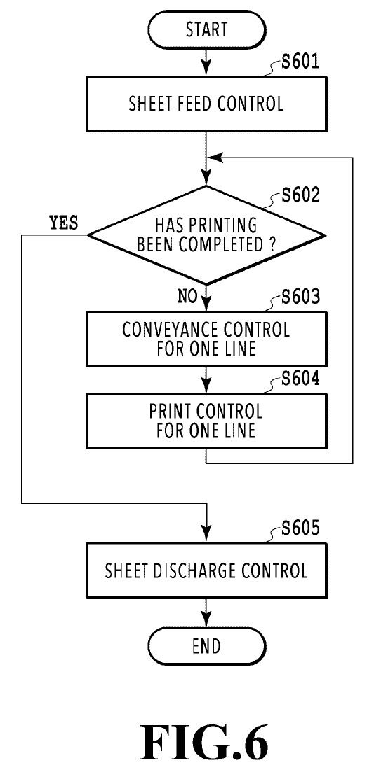

FIG. 6 is a flowchart illustrating an example of print control performed by the printing apparatus 101, and printing-medium conveyance control performed by the printing apparatus 101 and the feeder unit 120 in association with the print control. The processing operations shown in FIG. 6 are implemented by the CPU 201 of the printing apparatus 101 reading a program stored in the ROM 203 into the RAM 202 and executing the program. Note that some or all of the functions of the steps in FIG. 6 may be implemented using hardware such as an ASIC or an electronic circuit. The symbol "S" in the description of each of the processing operations denotes a step in the flowchart (hereinafter this also applies to other flowcharts in this specification).

The flowchart shown in FIG. 6 begins with the I/F control module 423 of the printing apparatus 101 receiving data to be printed, such as image data, from the host computer 220 via the USB cable 221 and then the job management application 411 providing an instruction to start printing.

At S601, the CPU 201 causes the job management application 411 to instruct the printer control module 421 to perform sheet feed control (described below). Through the sheet feed control in the feeder unit 120, a printing medium is conveyed to a position where the leading edge of the printing medium contacts the print roller 311. Note that, in a case where synchronized driving is required between motors controlled by the printing apparatus 101 and motors controlled by the feeder unit 120 during the sheet feed control, the printing-medium conveyance control, and the conveyance control associated with print control, processing operations shown in the sequence diagrams described below are performed.

At S602, the CPU 201 causes the job management application 411 to determine whether the printing has been completed. The completion of the printing means the formation of all the image corresponding to the print data on the printing medium. In a case where the job management application 411 determines at S602 that the printing has been completed (Yes), the CPU 201 proceeds to S605. In a case where the job management application 411 determines at S602 that the printing has not been completed (No), the CPU 201 proceeds to S603.

At S603, the CPU 201 causes the job management application 411 to instruct the printer control module 421 to control the conveyance of the printing medium based on the print data, so that the printer control module 421 conveys the printing medium in the downstream direction. The downstream direction refers to the direction in which the printing medium is conveyed through the conveyance path for printing media. For example, at S603, the CPU 201 causes the job management application 411 to instruct the printer control module 421 to control the conveyance of the printing medium by one line, so that the printer control module 421 conveys the printing medium by one line in the downstream direction. One line refers to the length of the image area printable with a single movement of the carriage 308, in terms of the length along the conveyance direction of the printing medium.

At S604, the CPU 201 causes the job management application 411 to instruct the printer control module 421 to form one line of image. The CPU 201 causes the printer control module 421 to form the image via the printer I/F 204 by ejecting ink from the print head 309 while driving the carriage motor 304.

At S605, the CPU 201 causes the job management application 411 to instruct the printer control module 421 to control sheet discharge. The CPU 201 causes the printer control module 421 to control the sheet discharge motor 303 via the printer I/F 204 to discharge the print product onto the output tray 102.

FIG. 7 is a sequence diagram illustrating an example of sheet feed control performed by the printer control module 421 of the printing apparatus 101 for feeding a printing medium from the sheet feeding cassette 121 or 122. The description in the present embodiment assumes, as an example, that the printing medium is fed from the sheet feeding cassette 122.

At S701, the printer control module 421 receives a sheet feeding instruction from the job management application 411. At S702, in response to the sheet feeding instruction received at S701, the printer control module 421 identifies the motor for feeding from the sheet feeding cassette 122, and instructs the serial communication control module 422 to transmit a motor driving instruction command for the identified motor. At S703, in response to the instruction at S702, the serial communication control module 422 transmits a motor driving instruction command to the serial communication control submodule 442 through serial communication via the local communication I/F 209. At S704, the serial communication control submodule 442 notifies the printer control submodule 441 of the motor driving instruction command received at S703.

At S705, the printer control submodule 441 drives the sheet feed motor 322 via the printer I/F 244 based on the motor driving instruction command notified at S704, thereby driving the sheet feed roller 329 and the conveyance roller pair 330. Because the motor driving instruction command does not require synchronization with other motors, this driving is performed immediately. Also at S705, the printer control submodule 441 continues feeding the printing medium until the sheet detection sensor 326 detects the printing medium. In a case where the sheet detection sensor 326 detects the printing medium, the printer control submodule 441 stops the sheet feed motor 322.

At S706, the printer control submodule 441 instructs the serial communication control submodule 442 to transmit a motor stop notification command in order to notify the printing apparatus 101 of the stop of the sheet feed motor 322. At this point, the printer control submodule 441 sets the cause of the stop in parameter P3 to notify that the motor has been stopped because of the detection of the printing medium by the sheet detection sensor 326. That is, the printing apparatus 101 can determine whether the stop of the sheet feed motor 322 is due to detection by the sheet detection sensor 326 based on the cause of the stop indicated in the received motor stop notification command . In a case where the cause of the stop in the received motor stop notification command does not indicate that the stop is due to detection by the sheet detection sensor 326, the printing apparatus 101 can determine the occurrence of a sheet feed failure in the feeder unit 120.

At S707, in response to the instruction at S706, the serial communication control submodule 442 transmits a motor stop notification command to the serial communication control module 422 through serial communication via the local communication I/F 246. At S708, the serial communication control module 422 notifies the printer control module 421 of the motor stop notification command received at S707.

The processing operations at S709 to S715 indicate repetitive control for each of the motors in the feeder unit 120 identified by the printing apparatus 101 as the motors that need to be driven to further convey the printing medium fed to the position of the sheet detection sensor 326. Specifically, in the present embodiment, the sheet feed motors 321 and 322 are to be driven. Note that, in the case of feeding from the sheet feeding cassette 121, the sheet feed motor 321 is to be driven, whereas the sheet feed motor 322 is not to be driven.

First, the description of this sequence illustrates, as an example, performing motor driving scheduling for the sheet feed motor 321. At S709, the printer control module 421 instructs the serial communication control module 422 to transmit a motor driving scheduling command in order to perform motor driving scheduling for the sheet feed motor 321. Motor driving scheduling refers to specifying a motor in advance through serial communication so that the specified motor can be driven in response to the reception of an interrupt signal. Performing motor driving scheduling enables using an interrupt signal to perform synchronized control (described below) of motors controlled in the printing apparatus 101 and motors controlled in the feeder unit 120.

At S710, in response to the instruction at S709, the serial communication control module 422 transmits a motor driving scheduling command to the serial communication control submodule 442 through serial communication via the local communication I/F 209. At S711, the serial communication control submodule 442 notifies the printer control submodule 441 of the motor driving scheduling command received at S710.

At S712, the printer control submodule 441 stores driving information for the sheet feed motor 321 as indicated by the parameters of the motor driving scheduling command received at S711. Also at S712, for the motor indicated by the motor driving scheduling command, the printer control submodule 441 sets the motor to be driven so that the motor can be immediately rotated via the printer I/F 244 upon the reception of an interrupt signal.

Upon completion of the motor driving setting, at S713, the printer control submodule 441 instructs the serial communication control submodule 442 to transmit a motor driving scheduling completion notification command in order to provide notification of the completion of the motor driving scheduling. At S714, in response to the instruction at S713, the serial communication control submodule 442 transmits a motor driving scheduling completion notification command to the serial communication control module 422 through serial communication via the local communication I/F 246. At S715, the serial communication control module 422 notifies the printer control module 421 of the motor driving scheduling completion notification command received at S714. This completes the motor driving scheduling for the sheet feed motor 321 and the notification of the completion thereof. The same processing operations are performed for the sheet feed motor 322. That is, the repetitive control at S709 to S715 is performed as many times as the number of motors that are controlled in the feeder unit 120 and are to be synchronized with a motor controlled in the printing apparatus 101.

At S716, the printer control module 421 sets the conveyance motor 301, controlled by the printing apparatus 101, to be driven, that is, the conveyance motor 301 is to be synchronized with the sheet feed motors 321 and 322 for which the motor driving scheduling has been performed.

At S717, the printer control module 421 instructs the serial communication control module 422 to start synchronized driving so that the sheet feed motors 321 and 322 for which the motor driving scheduling has been performed are driven simultaneously with the conveyance motor 301 that has been set to be driven at S716.

At S718, in response to the instruction at S717, the serial communication control module 422 transmits an interrupt signal to the serial communication control submodule 442 through the interrupt line via the local communication I/F 209. At S719, the serial communication control submodule 442 notifies the printer control submodule 441 of the reception of the interrupt signal at S718. At S720, the printer control submodule 441 starts, via the printer I/F 244, driving all the motors that have been set to be driven at S712.

At S721, following the instruction to start synchronized driving at S717, the printer control module 421 starts driving the conveyance motor 301 that has been set to be driven at S716. For example, the printer control module 421 starts driving the conveyance motor 301 a predetermined time (e.g., several milliseconds) after the instruction to start synchronized driving at S717, so that the start of driving the conveyance motor 301 coincides with the start of driving the sheet feed motors 321 and 322. The sheet feed motors 321 and 322 and the conveyance motor 301 are thus driven to convey the printing medium to a position beyond the sheet detection sensor 305. The driving amount of the conveyance motor 301 corresponds to the conveyance distance of the printing medium conveyed by the driving of the sheet feed motors 321 and 322 for which the motor driving scheduling has been performed. That is, the driving amount of the conveyance motor 301 corresponds to the driving amount of the sheet feed motors 321 and 322 for which the motor driving scheduling has been performed.

At S722, the printer control module 421 waits until the sheet detection sensor 305 detects the printing medium.

The processing operations at S723 to S726 indicate repetitive control for each of the motors in the feeder unit 120 identified by the printing apparatus 101 as the motors that need to be driven to adjust the position of the printing medium fed to the position of the sheet detection sensor 305. Adjusting the position of the printing medium fed to the position of the sheet detection sensor 305 means, for example, adjustment to cause the printing medium to reach the position where it contacts the print roller 311.

At S723, the printer control module 421 changes the driving amount indicated by the driving information stored at S712 to the driving amount required for the leading edge of the printing medium detected by the sheet detection sensor 305 to contact the print roller 311. Specifically, at S723, the printer control module 421 instructs the serial communication control module 422 to transmit a motor driving amount change command (change information) in order to change the driving amount of the motors in the feeder unit 120 for which the motor driving scheduling has been performed.

At S724, in response to the instruction at S723, the serial communication control module 422 transmits a motor driving amount change command to the serial communication control submodule 442 through serial communication via the local communication I/F 209. At S725, the serial communication control submodule 442 notifies the printer control submodule 441 of the motor driving amount change command received at S724. At S726, the printer control submodule 441 changes the driving amount indicated by the driving information stored at S712 to the driving amount indicated by parameter P2 of the motor driving amount change command notified at S725. At S727, the printer control module 421 changes the driving amount of the conveyance motor 301 that has been set to be driven at S716 to the driving amount required for the leading edge of the printing medium detected by the sheet detection sensor 305 to contact the print roller 311. The printing medium is then conveyed by the driving amount set at S726 and S727. The motors stop after being driven by the changed driving amount.

The processing operations at S728 to S731 indicate repetitive control for waiting for each of the motors in the feeder unit 120 driven at S720 to stop.

At S728, the printer control submodule 441 detects the stop of the sheet feed motor 321 or 322 in the feeder unit 120. At S729, the printer control submodule 441 instructs the serial communication control submodule 442 to transmit a motor stop notification command for the sheet feed motor detected at S728 in order to notify the printing apparatus 101 of the stop of the sheet feed motor 321 or 322. At S730, in response to the instruction at S729, the serial communication control submodule 442 transmits a motor stop notification command to the serial communication control module 422 through serial communication via the local communication I/F 246. At S731, the serial communication control module 422 notifies the printer control module 421 of the reception of the motor stop notification command at S730. At S732, the printer control module 421 waits for the conveyance motor 301 to stop, and this sequence terminates.

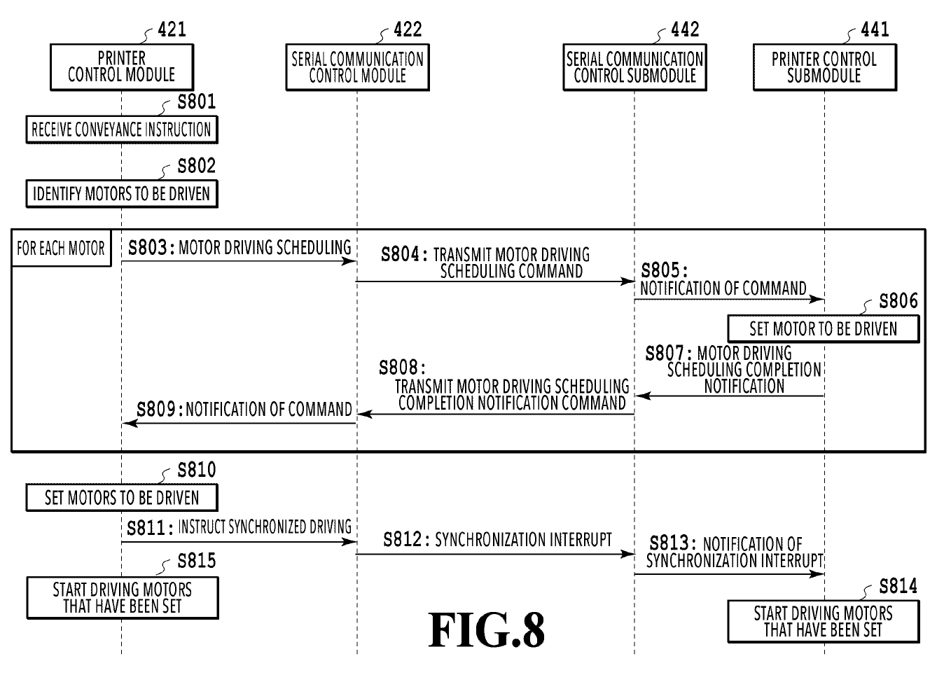

FIG. 8 is a diagram illustrating an example of a conveyance control sequence for controlling conveyance so that the printing medium conveyed to the print roller 311 is further conveyed downstream to reach under the print head 309. That is, the conveyance control shown in FIG. 8 is a series of control operations following the sheet feed control shown in FIG. 7.

At S801, the printer control module 421 receives a conveyance instruction from the job management application 411, including the motor driving amount for conveying the printing medium. At S802, the printer control module 421 identifies, based on the position of the printing medium, motors that should be driven. Specifically, in a case where the conveyance roller pair 310 is nipping the printing medium, the conveyance motor 301 is to be driven. In a case where the sheet discharge roller 313 is not currently contacting the printing medium but will contact the printing medium during the conveyance control, the sheet discharge motor 303 is also to be driven. In a case where the conveyance roller pair 328 is nipping the printing medium, the sheet feed motor 321 is to be driven. Note that, in this case, in a case where the conveyance roller pair 330 is not nipping the printing medium, the sheet feed motor 322 is excluded from the motors to be driven. The processing operations at S803 to S809 indicate repetitive control for motor driving scheduling for each of the motors in the feeder unit 120 identified at S802. Whether each roller pair is nipping the printing medium can be determined based on whether the sensor beside the roller pair detects the printing medium.

At S803, the printer control module 421 instructs the serial communication control module 422 to transmit a motor driving scheduling command in order to perform motor driving scheduling for a motor in the feeder unit 120 identified at S802. At S804, in response to the instruction at S803, the serial communication control module 422 transmits a motor driving scheduling command to the serial communication control submodule 442 through serial communication via the local communication I/F 209. At S805, the serial communication control submodule 442 notifies the printer control submodule 441 of the reception of the motor driving scheduling command at S804.

At S806, the printer control submodule 441 stores driving information for the sheet feed motor 321 as indicated by the parameters of the motor driving scheduling command received at S805. Also at S806, for the motor indicated by the motor driving scheduling command, the printer control submodule 441 sets the motor to be driven so that the motor can be immediately rotated via the printer I/F 244 upon the reception of an interrupt signal.

At S807, upon completion of the motor driving setting at S806, the printer control submodule 441 instructs the serial communication control submodule 442 to transmit a motor driving scheduling completion notification command in order to provide notification of the completion of the motor driving scheduling. At S808, in response to the instruction at S807, the serial communication control submodule 442 transmits a motor driving scheduling completion notification command to the serial communication control module 422 through serial communication via the local communication I/F 246. At S809, the serial communication control module 422 notifies the printer control module 421 of the motor driving scheduling completion notification command received at S808.

At S810, for the motors that should be controlled by the printing apparatus 101 depending on the position and conveyance amount of the printing medium, the printer control module 421 sets the motors to be driven so that the motors can be immediately driven. That is, this driving setting is performed for the motors to be synchronized with the motors for which the motor driving scheduling has been performed. Specifically, the conveyance motor 301, the print motor 302, and the sheet discharge motor 303 are to be driven. In a serial printer, which alternately performs printing medium conveyance and a print scan, the carriage motor 304 is also to be driven. The conveyance amount (conveyance distance) of the printing medium can be derived from the number of pulses of pulsed signals transmitted to the motors.

At S811, the printer control module 421 instructs the serial communication control module 422 to start synchronized driving so that the motors controlled by the feeder unit 120 and for which the motor driving scheduling has been performed are driven simultaneously with the motors that have been set to be driven at S810.

At S812, in response to the instruction at S811, the serial communication control module 422 transmits an interrupt signal to the serial communication control submodule 442 through the interrupt line via the local communication I/F 209. At S813, the serial communication control submodule 442 notifies the printer control submodule 441 of the reception of the interrupt signal at S812. At S814, the printer control submodule 441 starts, via the printer I/F 244, driving all the motors that have been set to be driven at S806. At S815, following the instruction to start synchronized driving at S811, the printer control module 421 starts driving the motors that have been set to be driven at S810.

Thus, in the present embodiment, the motors that should be controlled by the printing apparatus 101 are set to be driven at S810. Immediately after that, the instruction to start synchronized driving is issued at S811 to trigger motor driving.

In the present embodiment, which adopts a serial printer, the process shown in FIG. 8 is repeated for each print scan with the print head 309. Specifically, after a first print scan with the print head 309, the printing apparatus 101 performs the processing operations at S803 and S810 before a second print scan following the first print scan. Note that the timing of these steps is not limited to this. For example, during the first print scan, the processing operations at S803 to S810 corresponding to the printing medium conveyance operation for the second print scan may be completed. Then, upon completion of the first print scan, the processing operations at S811 and S815 for the second print scan may be performed simultaneously. This can prevent a productivity loss due to the communication time of serial communication.

Once the trailing edge of the printing medium is released from the conveyance roller pair 328, the processing operations at S803 to S809 and S811 to S814 are substantially invalid; the print scan proceeds under the control within the printing apparatus 101 alone. Furthermore, once all the image data is printed, the printing medium is discharged onto the output tray by the continuous driving of the sheet discharge motor 303.

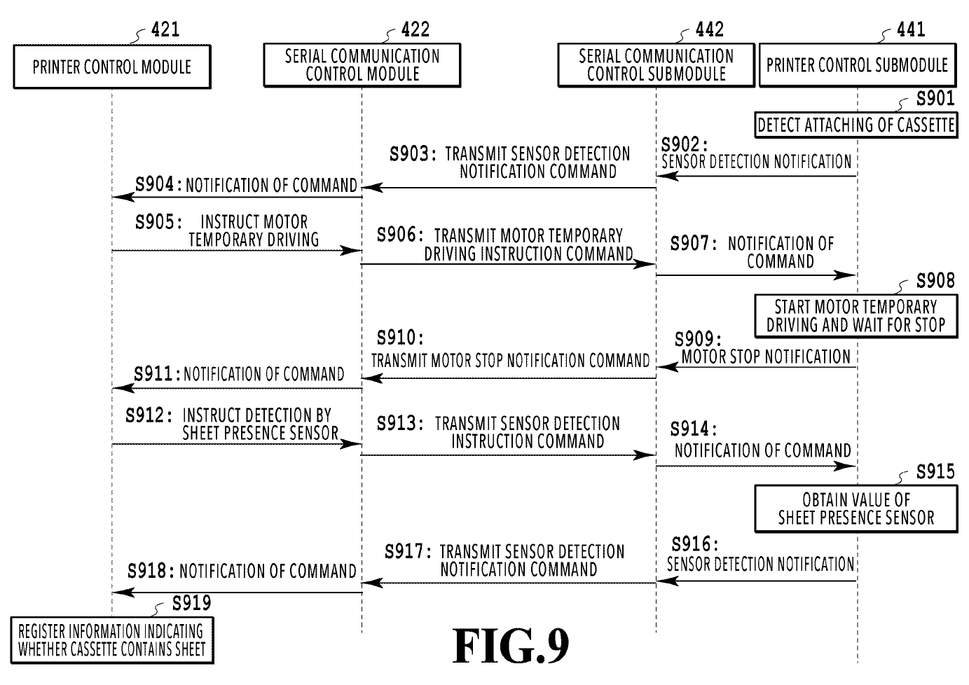

FIG. 9 is a sequence diagram illustrating an example of control performed in a case where the sheet feeding cassette 121 or 122 is attached to the printing apparatus 101. The description in the present embodiment assumes, as an example, that the sheet feeding cassette 122 is attached.

At S901, the printer control submodule 441 detects, via the cassette attaching/detaching detection sensor 334, the attaching of the sheet feeding cassette 122. At S902, the printer control submodule 441 instructs the serial communication control submodule 442 to transmit a sensor detection notification command in order to notify the printing apparatus 101 of the attaching of the sheet feeding cassette 122 at S901. At S903, in response to the instruction at S902, the serial communication control submodule 442 transmits a sensor detection notification command to the serial communication control module 422 through serial communication via the local communication I/F 246. At S904, the serial communication control module 422 notifies the printer control module 421 of the sensor detection notification command received at S903.

At S905, the printer control module 421 instructs the serial communication control module 422 to transmit a motor temporary driving instruction command in order to raise the pressure plate 332 of the attached sheet feeding cassette 122. At S906, in response to the instruction at S905, the serial communication control module 422 transmits a motor temporary driving instruction command to the serial communication control submodule 442 through serial communication via the local communication I/F 209. At S907, the serial communication control submodule 442 notifies the printer control submodule 441 of the motor temporary driving instruction command received at S906.

At S908, the printer control submodule 441 raises the pressure plate 332 of the sheet feeding cassette 122 by driving, via the printer I/F 244, the pressure plate motor 335 indicated by the motor temporary driving instruction command notified at S907. The printer control submodule 441 then waits for the pressure plate motor 335 to stop.

At S909, the printer control submodule 441 instructs the serial communication control submodule 442 to transmit a motor stop notification command in order to notify the printing apparatus 101 of the stop of the pressure plate motor 335 at S908. At S910, in response to the instruction at S909, the serial communication control submodule 442 transmits a motor stop notification command to the serial communication control module 422 through serial communication via the local communication I/F 246. At S911, the serial communication control module 422 notifies the printer control module 421 of the motor stop notification command received at S910.

At S912, the printer control module 421 instructs the serial communication control module 422 to transmit a sensor detection instruction command in order to obtain the value of the sheet presence sensor 324 for the attached sheet feeding cassette 122. At this point, the printer control module 421 may instruct the serial communication control module 422 to transmit a sensor detection instruction command in order to obtain the value of the sheet presence sensor 323 for the sheet feeding cassette 121 attached before the attaching of the sheet feeding cassette 122.

At S913, in response to the instruction at S912, the serial communication control module 422 transmits a sensor detection instruction command to the serial communication control submodule 442 through serial communication via the local communication I/F 209. At S914, the serial communication control submodule 442 notifies the printer control submodule 441 of the sensor detection instruction command received at S913. At S915, in response to the notification at S914, the printer control submodule 441 obtains the value of the sheet presence sensor 324.

At S916, the printer control submodule 441 instructs the serial communication control submodule 442 to transmit a sensor detection notification command in order to notify the printing apparatus 101 of the value obtained at S915 (i.e., the value indicating whether a sheet is present). At S917, in response to the instruction at S916, the serial communication control submodule 442 transmits a sensor detection notification command to the serial communication control module 422 through serial communication via the local communication I/F 246. At S918, the serial communication control module 422 notifies the printer control module 421 of the sensor detection notification command received at S917. At S919, based on the value of the sheet presence sensor 324 for the sheet feeding cassette 122 included in the sensor detection notification command notified at S918, the printer control module 421 registers information indicating whether a sheet is present.

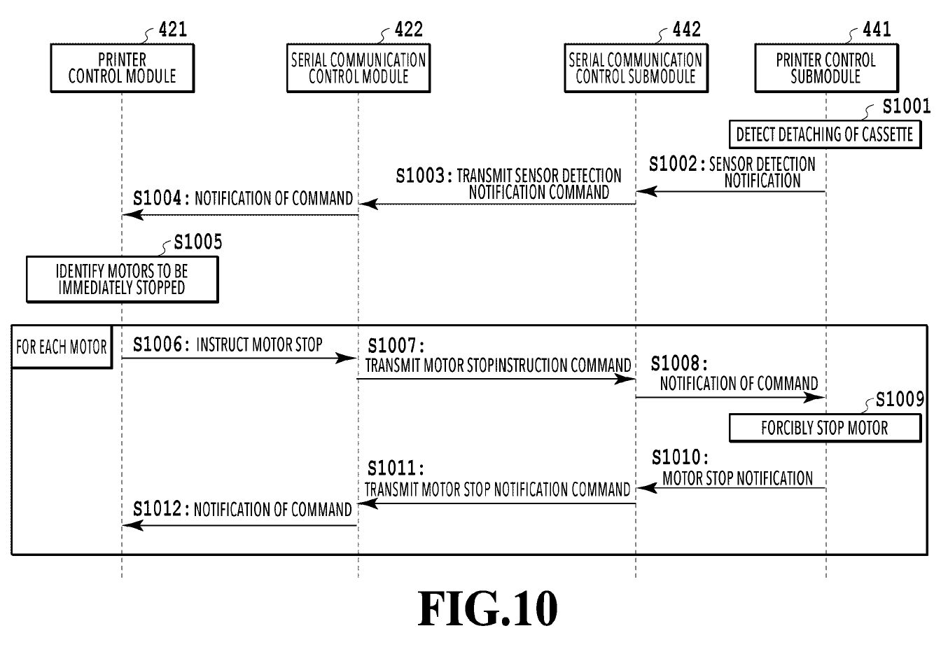

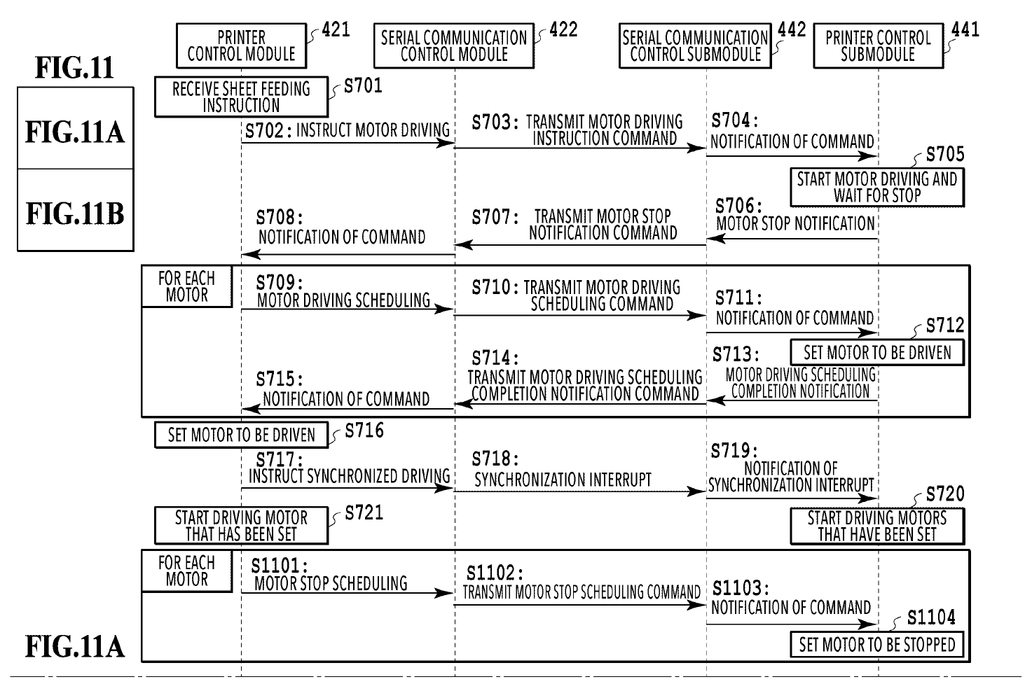

FIG. 10 is a sequence diagram illustrating an example of motor stop control performed in a case where the sheet feeding cassette 121 or 122 is pulled out during sheet feed control or conveyance control that uses one or both of the sheet feed motors 321 and 322. The description in the present embodiment assumes, as an example, that the sheet feeding cassette 121 is pulled out from the printing apparatus 101 during sheet feed control performed in the sheet feeding cassette 122. Because the sheet feeding cassette 121 includes part of the conveyance path for printing media conveyed from the sheet feeding cassette 122, pulling out the sheet feeding cassette 121 disconnects the conveyance path from the conveyance path in the printing apparatus 101. Motor control then needs to be immediately stopped for ensuring user safety.

At S1001, the printer control submodule 441 monitors for a change in the cassette attaching/detaching detection sensor 333 and detects that the user has pulled out the sheet feeding cassette 121. At S1002, the printer control submodule 441 instructs the serial communication control submodule 442 to transmit a sensor detection notification command in order to notify the printing apparatus 101 of the pulling out of the sheet feeding cassette 121. At S1003, in response to the instruction at S1002, the serial communication control submodule 442 transmits a sensor detection notification command to the serial communication control module 422 through serial communication via the local communication I/F 246. At S1004, the serial communication control module 422 notifies the printer control module 421 of the sensor detection notification command received at S1003.

At S1005, the printer control module 421 identifies motors to be immediately stopped. Specifically, for the sheet feeding cassette 121 pulled out during sheet feeding from the sheet feeding cassette 122, both the sheet feed motors 321 and 322 are to be stopped. The processing operations at S1006 to S1012 indicate repetitive control for immediately stopping each of the motors identified at S1005. The following will describe an example of immediately stopping the sheet feed motor 321.

At S1006, the printer control module 421 instructs the serial communication control module 422 to transmit a motor stop instruction command in order to immediately stop the sheet feed motor 321. At S1007, in response to the instruction at S1006, the serial communication control module 422 transmits a motor stop instruction command to the serial communication control submodule 442 through serial communication via the local communication I/F 209. At S1008, the serial communication control submodule 442 notifies the printer control submodule 441 of the motor stop instruction command received at S1007. At S1009, the printer control submodule 441 forcibly stops the sheet feed motor 321 indicated by the parameter of the motor stop instruction command notified at S1008.

At S1010, the printer control submodule 441 instructs the serial communication control submodule 442 to transmit a motor stop notification command in order to notify the printing apparatus 101 of the stop of the sheet feed motor 321. At S1011, in response to the instruction at S1010, the serial communication control submodule 442 transmits a motor stop notification command to the serial communication control module 422 through serial communication via the local communication I/F 246. At S1012, the serial communication control module 422 notifies the printer control module 421 of the motor stop notification command received at S1011. The processing operations at S1006 to S1012 are also performed for the sheet feed motor 322 in the same manner as for the sheet feed motor 321.

In the above-described example in the present embodiment, the sheet feeding cassette 121 is pulled out during sheet feeding from the sheet feeding cassette 122. In a case where the sheet feeding cassette 122 is pulled out during sheet feeding from the sheet feeding cassette 122, only the sheet feed motor 322 is to be forcibly stopped. Similarly, in a case where the sheet feeding cassette 121 is pulled out during sheet feeding from the sheet feeding cassette 121, only the sheet feed motor 321 is to be forcibly stopped. However, in a case where the sheet feeding cassette 122 is pulled out during sheet feeding from the sheet feeding cassette 121, the sheet feed motor 321 does not need to be stopped.

According to the present embodiment, motors controlled by the printing apparatus 101 and motors controlled by the feeder unit 120 can be synchronously driven through a simple communication method that uses a serial communication line and an interrupt line. By transmitting commands in advance via the serial communication line to set motors that should be synchronously driven and their driving amounts, the timing of starting and stopping the driving of the motors can be aligned. Thus, higher-precision conveyance control of a printing medium can be achieved using a simple communication method.

### Second embodiment

The first embodiment has described an example in which, in a case where a sheet feeding cassette is pulled out during sheet feed control, the printing apparatus 101 instructs the feeder unit 120 to stop motors that depend on which sheet feeding cassette is feeding and which sheet feeding cassette has been pulled out. The present embodiment will describe an example in which the printing apparatus 101 performs motor stop scheduling for motors being driven in the feeder unit 120, and then transmits an interrupt signal via the interrupt line to cause the motors to be stopped. Note that the basic configuration of the printing apparatus 101 and the feeder unit 120 in the present embodiment are the same as that in the first embodiment, and therefore will not be described in detail.

In the description of FIG. 10 in the first embodiment, the feeder unit 120 notifies the printing apparatus 101 that the sheet feeding cassette 121 has been pulled out, and the printing apparatus 101 instructs the feeder unit 120 to stop sheet feed motors. Thus, in the first embodiment, at least two communications occur via the serial communication line before the motors are stopped. In a case where stopping the motors takes longer than a predetermined length of time (e.g., 100 milliseconds), ensuring user safety may be difficult. That is, in a case where the motors can be stopped within a predetermined time period after the sheet feeding cassette is pulled out, user safety can be ensured because it is unlikely that the user will touch a still driven roller after pulling out the sheet feeding cassette. In a case where stopping the motors takes longer than this, control is necessary for more quickly stopping the motors. The present embodiment will describe control capable of stopping the motors quickly by reducing the number of communications via the serial communication line. This can ensure user safety.

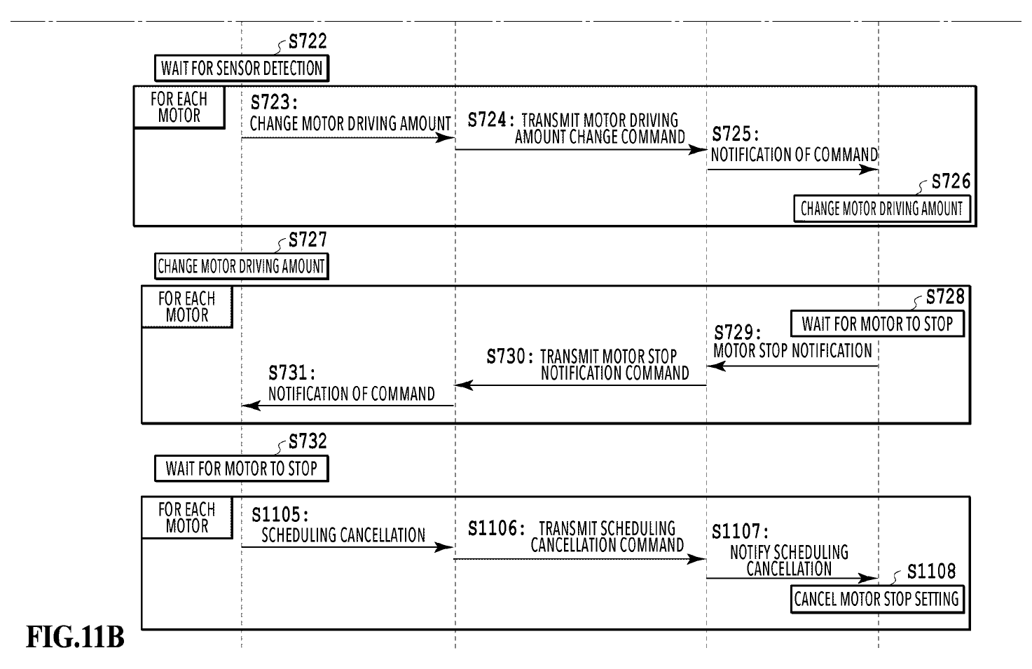

FIG. 11 is a diagram illustrating an example of motor stop scheduling performed by the printing apparatus 101 and the feeder unit 120 in the present embodiment. Specifically, FIG. 11 is a diagram illustrating an example in which the printing apparatus 101 performs motor stop scheduling during the sheet feed control shown in FIG. 7 in the first embodiment. Motor stop scheduling refers to specifying a motor in advance so that the specified motor can be stopped in response to the reception of an interrupt signal on the occurrence of a predetermined event (e.g., an event of a user pulling out a sheet feeding cassette).

As in the first embodiment, the description in the present embodiment assumes, as an example, that a printing medium is fed from the sheet feeding cassette 122. Note that the processing operations at S701 to S732 shown in FIG. 11 in the second embodiment are the same as those with the same reference numerals shown in FIG. 7 in the first embodiment, and therefore will not be described. The following will describe differences from the first embodiment.

After starting the motor driving at S721, the printing apparatus 101 performs motor stop scheduling for the sheet feed motors being driven, in order to prepare for the pulling out of a sheet feeding cassette while the motors are being driven. The processing operations at S1101 to S1104 indicate repetitive control for motor stop scheduling for each of the motors being driven.

At S1101, the printer control module 421 instructs the serial communication control module 422 to transmit a motor stop scheduling command in order to perform motor stop scheduling. At S1102, in response to the instruction at S1101, the serial communication control module 422 transmits a motor stop scheduling command to the serial communication control submodule 442 through serial communication via the local communication I/F 209. At S1103, the serial communication control submodule 442 notifies the printer control submodule 441 of the motor stop scheduling command received at S1102.

At S1104, for the motor indicated by the motor stop scheduling command notified at S1103, the printer control submodule 441 sets the motor to be stopped (sets motor stop information) so that the motor can be immediately stopped upon the reception of an interrupt signal.

After waiting for the conveyance motor 301 to stop at S732, the printing apparatus 101 cancels the motor stop scheduling for the motors that have been set to be stopped through the processing operations at S1101 to S1104. The processing operations at S1105 to S1108 indicate repetitive control for cancelling the motor stop scheduling for each of the motors that have been set to be stopped through the processing operations at S1101 to S1104.

At S1105, the printer control module 421 instructs the serial communication control module 422 to transmit a scheduling cancellation command in order to cancel the motor stop scheduling for a motor that has been set to be stopped. At S1106, in response to the instruction at S1105, the serial communication control module 422 transmits a scheduling cancellation command to the serial communication control submodule 442 through serial communication via the local communication I/F 209. At S1107, the serial communication control submodule 442 notifies the printer control submodule 441 of the scheduling cancellation command received at S1106.

At S1108, the printer control submodule 441 cancels the stop setting for the motor indicated by the parameter of the scheduling cancellation command notified at S1107. Thus, in the control shown in FIG. 11, the motor stop scheduling is canceled by the printer control module 421 instructing the cancellation of the motor stop scheduling. However, the manner of canceling the motor stop scheduling is not limited to this. For example, the printer control submodule 441 may automatically cancel the motor stop scheduling in response to detecting at S728 that the motor being driven has stopped.

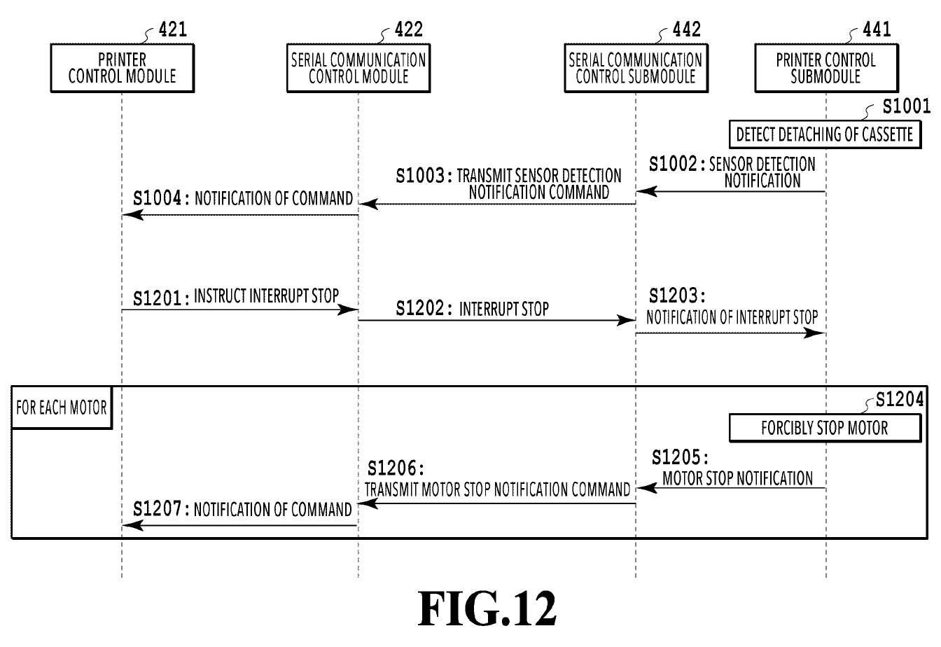

FIG. 12 is a diagram illustrating an example of motor stop control performed by the printing apparatus 101 and the feeder unit 120 in the present embodiment. Specifically, FIG. 12 is a diagram showing a variation of the motor stop control shown in FIG. 10 in the first embodiment, and illustrating motor stop control performed in a case where a user pulls out a sheet feeding cassette subsequent to the motor stop scheduling shown in FIG. 11. As in the first embodiment, the description in the present embodiment assumes, as an example, that a printing medium is fed from the sheet feeding cassette 122. Note that the processing operations at S1001 to S1004 shown in FIG. 12 in the second embodiment are the same as those with the same reference numerals shown in FIG. 10 in the first embodiment, and therefore will not be described. The following will describe differences from the first embodiment.

At S1201, the printer control module 421 instructs the serial communication control module 422 to issue interrupt stop, in order to stop the motors being driven in the feeder unit 120. At S1202, in response to the instruction at S1201, the serial communication control module 422 transmits an interrupt stop signal to the serial communication control submodule 442 through the interrupt line via the local communication I/F 209. At S1203, the serial communication control submodule 442 notifies the printer control submodule 441 of the reception of the interrupt stop signal at S1202. The interrupt stop signal may be the same type of signal as the interrupt signal transmitted at S718. That is, depending on the details set by the motor driving scheduling or the motor stop scheduling, the printer control submodule 441 performs a processing operation indicated by the details upon receiving an interrupt signal. Alternatively, an interrupt stop signal of a type different from the interrupt signal may be used in the present disclosure.

The processing operations at S1204 to S1207 indicates repetitive control for stopping each of the motors that have been set to be stopped in advance through the motor stop scheduling in FIG. 11. In a case where no motor stop scheduling has been performed, the processing operations at S1204 to S1207 are not performed and this sequence terminates.

At S1204, the printer control submodule 441 forcibly stops a motor that has been set to be stopped in advance through the motor stop scheduling. At S1205, the printer control submodule 441 instructs the serial communication control submodule 442 to transmit a motor stop notification command in order to notify the printing apparatus 101 of the stop of the motor at S1204. At S1206, in response to the instruction at S1205, the serial communication control submodule 442 transmits a motor stop notification command to the serial communication control module 422 through serial communication via the local communication I/F 246. At S1207, the serial communication control module 422 notifies the printer control module 421 of the motor stop notification command received at S1206.

Thus, in the control shown in FIG. 12, the motors are stopped by the feeder unit 120 transmitting a notification of the pulling out of a sheet feeding cassette to the printing apparatus 101 and receiving an interrupt stop signal. However, the manner of stopping the motors is not limited to this. For example, in the motor stop scheduling, the feeder unit 120 may set a predetermined condition that the motors are immediately stopped in a case where a sheet feeding cassette is pulled out. In a case where a sheet feeding cassette is pulled out, the feeder unit 120 may stop the motors without waiting for the reception of an interrupt stop signal.

According to the present embodiment, in a case where a sheet feeding cassette is pulled out from the main body of the printing apparatus 101, the motors that have been set to be stopped are stopped in response to the reception of an interrupt signal. This enables quickly stopping the motors, thereby ensuring user safety while achieving the same effects as those in the first embodiment.

### Other embodiments

The above embodiments have illustrated an exemplary relationship between the printing apparatus 101 and the feeder unit 120 that is located upstream along the conveyance path for printing media. Alternatively, the control operations in the above embodiments may be applied to a combination of the printing apparatus 101 and a discharging unit that is located downstream along the conveyance path for printing media.

The present disclosure may also be implemented by supplying a program for carrying out one or more functions of the above embodiments to a system or device via a network or storage medium and causing a computer of the system or device to read and execute the program. The computer may have one or more processors or circuits, and may include a network of separate computers or separate processors or circuits in order to read and execute computer-executable instructions.

The processors or circuits may include a central processing unit (CPU), a microprocessing unit (MPU), a graphics processing unit (GPU), an application-specific integrated circuit (ASIC), and a field-programmable gate array (FPGA). The processors or circuits may also include a digital signal processor (DSP), a data flow processor (DFP), and a neural processing unit (NPU).

The storage medium may also be referred to as a non-transitory computer-readable medium. The storage medium may include one or more hard disks (HD), random access memory (RAM), read-only memory (ROM), and storage devices in a distributed computing system. The storage medium may also include an optical disc (e.g., a compact disc (CD), a digital versatile disc (DVD), or a Blu-ray disc (BD, registered trademark)), a flash memory device, and a memory card.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2025-065060, filed Apr. 10, 2025, which is hereby incorporated by reference herein in its entirety.

What is claimed is:

1. A printing apparatus comprising:
a first conveyance unit configured to convey a printing medium along a conveyance path for conveying the printing medium;
a second conveyance unit located upstream from the first conveyance unit in a direction in which the printing medium is conveyed through the conveyance path; and
at least one memory and at least one processor which function as:
a first control unit configured to control the first conveyance unit; and
a second control unit configured to control the second conveyance unit and connected to the first control unit via a communication line, wherein
the first control unit
transmits, to the second control unit, driving information on a driving amount of the second conveyance unit for scheduling of driving of the second conveyance unit, and receives a notification of completion of the scheduling from the second control unit, and
thereafter transmits, to the second control unit, an interrupt signal for driving the second conveyance unit in synchronization with the first conveyance unit based on the driving information, and drives the first conveyance unit.

2. The printing apparatus according to claim 1, wherein the driving information is transmitted via a serial communication line, and the interrupt signal is transmitted via an interrupt signal line.

3. The printing apparatus according to claim 1, wherein the second control unit
sets the second conveyance unit based on the driving information before receiving the interrupt signal, and
drives the second conveyance unit based on the driving information upon receiving the interrupt signal.

4. The printing apparatus according to claim 1, wherein the driving information is in a predetermined format in which information on a conveyance speed and a conveyance distance of the printing medium by the second conveyance unit is specified.

5. The printing apparatus according to claim 1, further comprising a detection unit configured to detect a position of the printing medium passing through the conveyance path, wherein
based on the position of the printing medium detected by the detection unit, the first control unit transmits, to the second control unit, chang information for changing a driving amount of the second conveyance unit.

6. The printing apparatus according to claim 5, wherein the first control unit transmits the chang information, and changes a driving amount of the first conveyance unit based on the position of the printing medium detected by the detection unit.

7. The printing apparatus according to claim 5, wherein
the detection unit is a sensor that detects presence or absence of the printing medium at a nip portion of a conveyance roller provided in the first conveyance unit, and
the changing information is information for changing the driving amount of the second conveyance unit to a driving amount corresponding to a conveyance distance required for a leading edge of the printing medium to be conveyed from the nip portion to a position where image printing is possible.

8. The printing apparatus according to claim 1, comprising:
a first unit including the first conveyance unit and the first control unit; and
a second unit detachably attachable to the first unit and including the second conveyance unit and the second control unit.

9. The printing apparatus according to claim 8, further comprising an attaching/detaching detection unit configured to detect attaching and detaching of the second unit to and from the first unit, wherein
in a case where the attaching/detaching detection unit detects detaching of the second unit from the first unit, the second control unit stops the second conveyance unit based on stopping information for stopping the second conveyance unit scheduled by the first control unit.

10. The printing apparatus according to claim 9, wherein the first control unit
transmits the stopping information to the second control unit after transmitting the interrupt signal to the second control unit, and
in a case where a notification that the second unit has been detached from the first unit is received, transmits, to the second control unit, an interrupt signal for stopping the second conveyance unit based on the stopping information.

11. The printing apparatus according to claim 10, wherein the second control unit
notifies, in a case where the attaching/detaching detection unit detects detaching of the second unit from the first unit, the first control unit of information on detection of the detaching, and
stops the second conveyance unit in response to receiving the interrupt signal for stopping the second conveyance unit from the first control unit.

12. The printing apparatus according to claim 9, wherein the first control unit
transmits the stopping information to the second control unit after transmitting the interrupt signal to the second control unit, and
in a case of completion of the driving of the second conveyance unit triggered by the interrupt signal, transmits information for cancelling the stopping information to the second control unit.

13. The printing apparatus according to claim 9, wherein the stopping information is in a predetermined format in which information on stopping the driving of the second conveyance unit is specified.

14. The printing apparatus according to claim 1, wherein the printing apparatus is a serial printer that intermittently forms an image on the printing medium by alternately repeating a print scan on the printing medium with a print head and a conveyance operation of the printing medium.

15. A method for controlling a printing apparatus, the printing apparatus comprising:
a first conveyance unit configured to convey a printing medium along a conveyance path for conveying the printing medium;
a second conveyance unit located upstream from the first conveyance unit in a direction in which the printing medium is conveyed through the conveyance path;
a first control unit configured to control the first conveyance unit; and
a second control unit configured to control the second conveyance unit and connected to the first control unit via a communication line,
the method comprising:
transmitting, from the first control unit to the second control unit, driving information on a driving amount of the second conveyance unit for scheduling of driving of the second conveyance unit;
providing a notification of completion of the scheduling from the second control unit to the first control unit; and
transmitting, from the first control unit to the second control unit, an interrupt signal for driving the second conveyance unit in synchronization with the first conveyance unit based on the driving information, and starting to drive the first conveyance unit.

16. A system comprising:
a first unit including a first conveyance unit configured to convey a printing medium along a conveyance path for conveying the printing medium, and a first control unit configured to control the first conveyance unit; and
a second unit detachably attachable to the first unit and including a second conveyance unit located upstream from the first conveyance unit in a direction in which the printing medium is conveyed through the conveyance path, and a second control unit configured to control the second conveyance unit and connectable to the first control unit via a communication line, wherein
the first control unit
transmits, to the second control unit, driving information on a driving amount of the second conveyance unit for scheduling of driving of the second conveyance unit, and receives a notification of completion of the scheduling from the second control unit, and
thereafter transmits, to the second control unit, an interrupt signal for driving the second conveyance unit in synchronization with the first conveyance unit based on the driving information, and drives the first conveyance unit.
